(19) United States
(12) Patent Application Publication
(10) Pub. No.: US 2020/0015468 A1
(43) Pub. Date: Jan. 16, 2020

(54) PEDESTAL-MOUNTED MINNOW BUCKET HOLDER

(71) Applicant: Bailey C. Jelinek, Olathe, KS (US)

(72) Inventor: Bailey C. Jelinek, Olathe, KS (US)

(21) Appl. No.: 16/031,839

(22) Filed: Jul. 10, 2018

(51) Int. Cl. A01K 97/05; F16B 2/06

(52) U.S. Cl. CPC A01K 97/05; A01K 97/22; F16B 2/065

(57) ABSTRACT

A pedestal-mountable minnow bucket holder includes an annular ring having a top surface and an opposite bottom surface. The annular ring has a central plane defined between the top and bottom surfaces. A rod is coupled to the annular ring and extends radially outward therefrom substantially parallel to the central plane. In addition, a connecting clamp is coupled to the rod opposite the annular ring. The connecting clamp has a yoke defining a gap for at least partially receiving a pedestal extending through the connecting clamp. The yoke includes a first planar wall and a second planar wall oriented at a right angle to the first planar wall. The first and second planar walls define a first corner of the yoke.

### FIELD OF THE DISCLOSURE

The field of the disclosure relates generally to an apparatus for supporting equipment, and more particularly, to an apparatus for supporting a fishing bait container such as a minnow bucket.

### BACKGROUND OF THE DISCLOSURE

At least some known boats have seats mounted on pedestals to allow a fisherman to sit at an elevated position while fishing. However, while the fisherman sits on such pedestal mounted seats, the fisherman has nowhere to conveniently place various items that come in handy for fishing, such as a fishing bait container or minnow bucket. As a result, the fisherman often places the fishing bait container on the deck of the boat adjacent the pedestal mounted seat. Such placement, however, requires the fisherman to interrupt his or her fishing by leaving the elevated seat to fetch additional bait when needed, which may result in upsetting the boat, tipping over the fishing bait container, other accidents as a result of moving along the boat deck, wasted time, opportunity loss, and the like.

### BRIEF DESCRIPTION OF THE DISCLOSURE

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

In one aspect, a pedestal-mountable minnow bucket holder is provided. The pedestal-mountable minnow bucket holder has a longitudinal axis and includes an annular ring having a top surface and an opposite bottom surface. The annular ring defines a central plane between the top and bottom surfaces. In addition, the pedestal-mountable minnow bucket holder includes a rod coupled to the annular ring. The rod extends radially outward from the annular ring substantially parallel to the central plane. Moreover, the pedestal-mountable minnow bucket holder includes a connecting clamp coupled to the rod opposite the annular ring. The connecting clamp includes a yoke defining a gap for at least partially receiving a pedestal extending through the connecting clamp. The yoke includes a first planar wall and a second planar wall oriented at a right angle to the first planar wall, thereby defining a first corner of the yoke.

In another aspect, another pedestal-mountable minnow bucket holder is provided. The pedestal-mountable minnow bucket holder includes a plate-like body having a semi-circular first end presenting a first radius. The first end defines a first opening sized and configured to receive a minnow bucket. The pedestal-mountable minnow bucket holder also includes a semi-circular second end presenting a second radius smaller than the first radius. The second end defines a second opening sized and configured to receive at least a portion of a pedestal therethrough. Furthermore, the pedestal-mountable minnow bucket holder includes a tapered center portion extending between the first end and the second end. The tapered center section includes at least one straight edge oriented tangent to the first end and the second end.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a pedestal seat having a pedestal-mountable minnow bucket holder assembly coupled thereto, according to one embodiment of the disclosure;

FIG. 2 is a top right perspective view of the pedestal-mountable minnow bucket holder assembly shown in FIG. 1, with a locking knob assembly exploded away (threadedly detached) from a minnow bucket holder;

FIG. 3 is a top left perspective view of the pedestal-mountable minnow bucket holder assembly as shown in FIG. 2;

FIG. 4 is a top view of the pedestal-mountable minnow bucket holder shown in FIG. 1, with the locking knob assembly being wholly removed;

FIG. 5 is a side view of pedestal-mountable minnow bucket holder as shown in FIG. 4;

FIG. 6 is a perspective view of a pedestal seat assembly having an alternative pedestal-mountable minnow bucket holder, according to another embodiment of the disclosure;

FIG. 7 is a top perspective view of the pedestal-mountable minnow bucket holder shown in FIG. 6;

FIG. 8 is a bottom perspective view of the pedestal-mountable minnow bucket holder shown in FIG. 6;

FIG. 9 is a top view of the pedestal-mountable minnow bucket holder shown in FIG. 6;

FIG. 10 is a cross-sectional view of the pedestal-mountable minnow bucket holder taken about a line 10-10 of FIG. 9;

FIG. 11 is a top perspective view of an alternative pedestal-mountable minnow bucket holder, according to another embodiment of the disclosure; and

FIG. 12 is a top view of the pedestal-mountable minnow bucket holder shown in FIG. 11.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure can include a variety of combinations and/or integrations of the embodiments described herein.

In the following specification and the claims, reference will be made to several terms, which shall be defined to have the following meanings. The singular forms “a,” “an,” and “the” include plural references unless the context clearly dictates otherwise. “Optional” or “optionally” means that the subsequently described feature, event, or circumstance may or may not be required or occur, and that the description includes instances with or without such element.

Approximating language, as used herein throughout the specification and the claims, may be applied to modify any quantitative representation that could permissibly vary without resulting in a change in the basic function to which it is related. Accordingly, a value modified by a term or terms, such as “about,” “approximately,” and “substantially” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, directional references, such as, “top,” “bottom,” “front,” “back,” “side,” and similar terms are used herein solely for convenience and should be understood only in relation to each other. For example, a component might in practice be oriented such that faces referred to herein as “top” and “bottom” are in practice sideways, angled, inverted, etc. relative to the chosen frame of reference.

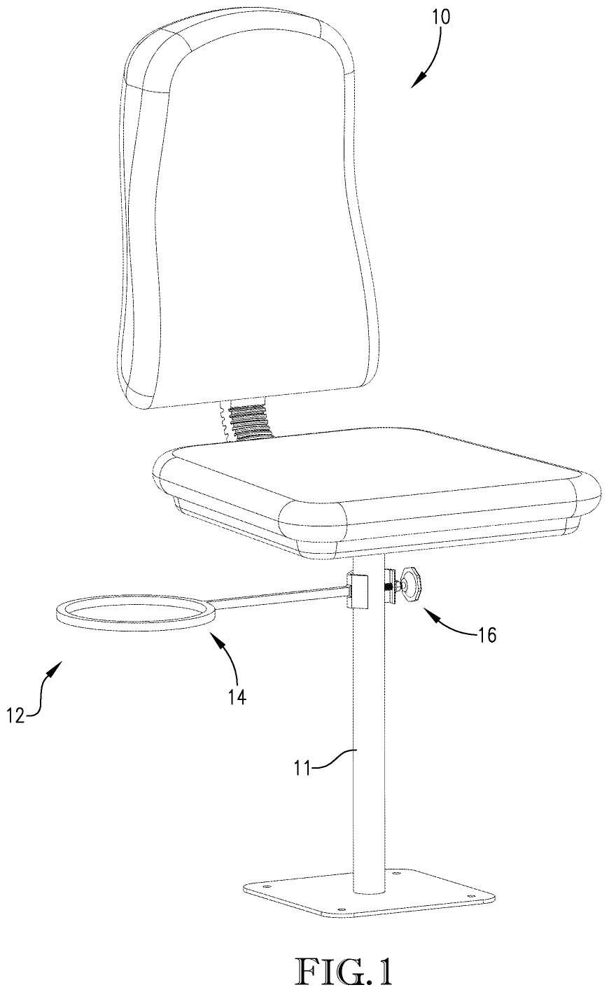

FIG. 1 is a perspective view of a pedestal seat 10 having a pedestal-mountable minnow bucket holder assembly 12 (broadly, a fishing bait container holding assembly) coupled thereto, according to one embodiment of the disclosure. In the exemplary embodiment, the pedestal mountable minnow bucket holder assembly 12 includes a minnow bucket holder body 14 and a locking knob assembly 16, which is threadedly coupled to the minnow bucket holder body 14 to releasably secure the minnow bucket holder body 14 to the pedestal seat 10. In particular, the pedestal-mountable minnow bucket holder assembly 12 is releasably coupled to a pedestal 11 of the pedestal seat 10.

In the exemplary embodiment, the locking knob assembly 16 is one of any typical knobs having an integral threaded stud. For example, and without limitation, the locking knob assembly 16 of the present disclosure includes a high-temperature plastic knob having an integral metal (e.g., steel) threaded stud configured to threadedly engage the minnow bucket holder body 14. In alternative embodiments, a mechanism for frictionally engaging the pedestal 11 and securing the minnow bucket holder body 14 in place might not have a knob (e.g., requiring a wrench or other tool to tighten the mechanism) or might be latched or otherwise coupled to the minnow bucket holder body 14.

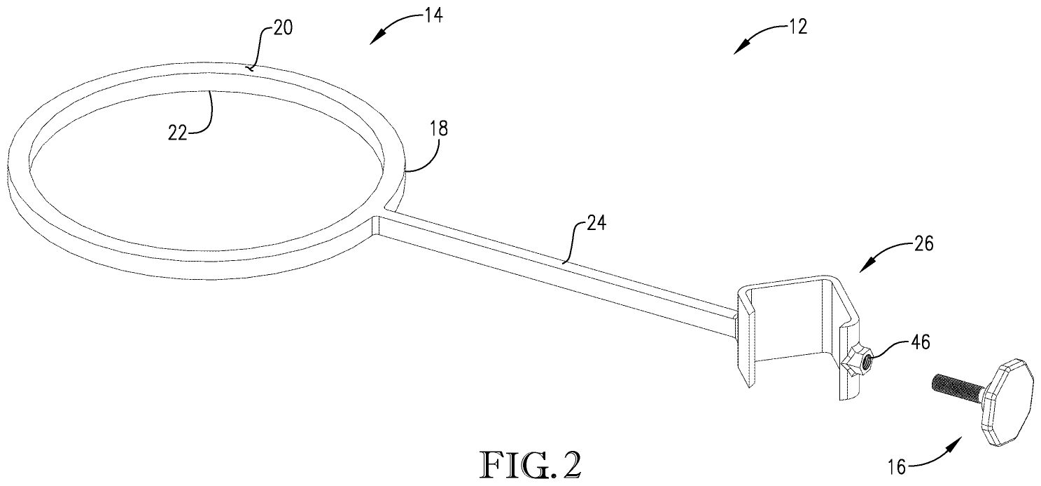

In the exemplary embodiment, as illustrated in FIGS. 2-5, the minnow bucket holder body 14 includes a generally planar annular ring 18 and a rod 24 extending outward therefrom. The term “annular,” as used herein, is not limited to the description of circular ring-shaped openings. Rather, it is contemplated that annular shapes include, for example, and without limitation, shapes that are round, polygonal, rectangular, oval, and/or racetrack-like with two generally parallel sides joined by rounded ends. In addition, the term “ring,” as used herein, is broad and includes a shape that may be substantially continuous or alternatively have one or more discontinuities while still being ring shaped.

The annular ring 18 and rod 24 define a top surface 20 and a substantially parallel opposite bottom surface 22 spaced a predefined distance “T₁” from the top surface 20. The distance T₁ is in a range between and including about one-quarter of an inch (¼″) and about one inch (1″). In the exemplary embodiment, the distance T₁ is preferably about one-half of an inch (½″).

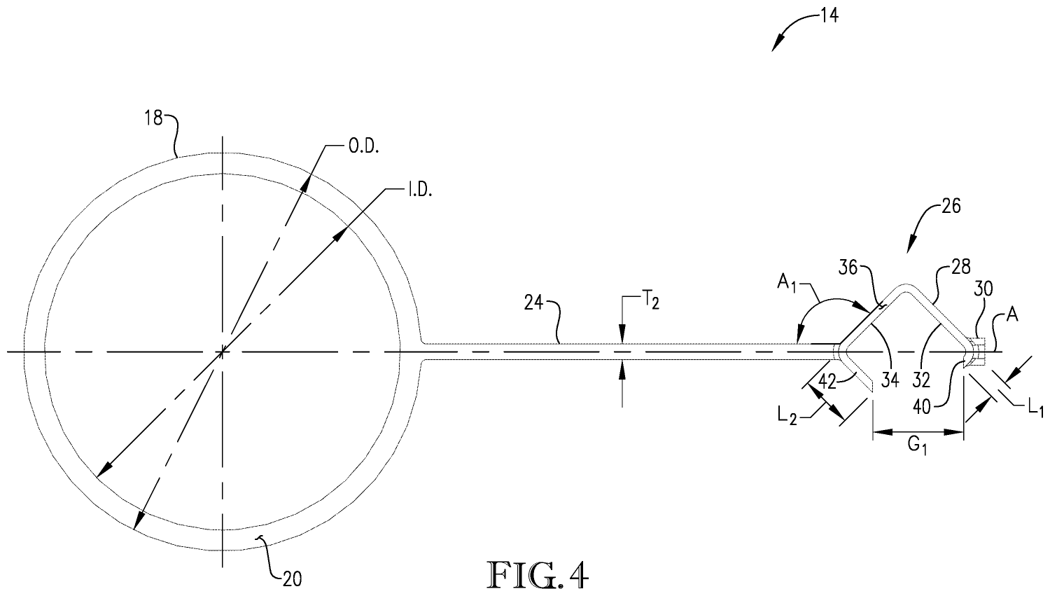

In the illustrated embodiment, the rod 24 is substantially linear and is coupled to the annular ring 18, defining a longitudinal axis “A” (shown in FIG. 4) of the minnow bucket holder body 14. The rod 24 extends radially from the annular ring 18, and as such, the longitudinal axis A intersects a center point of the annular ring 18. It is contemplated that the rod 24 need not be linear, but may include, for example, a curvilinear shape. In addition, in some embodiments, it is contemplated that the rod 24 may from the annular ring 18 along a direction other than along a radius of the annular ring.

In the exemplary embodiment, the annular ring 18 has an outside diameter “OD” and a concentric inside diameter “ID.” The ID is sized and shaped to receive a typical minnow bucket or other bait container (not shown) at least partially therethrough. A typical minnow bucket may include, for example, a tapered sidewall and/or an upper collar (or shoulder) that enables the annular ring 18 to engage therewith to prevent the minnow bucket from sliding therethrough. The ID is in a range between and including about seven inches (7″) and about ten inches (10″). In the exemplary embodiment, the ID is preferably about eight and one-half inches (8½″).

The OD is sized and shaped to facilitate presenting a cross-sectional shape of the annular ring sufficient in strength to support the minnow bucket holder and any substance contained therein. In the exemplary embodiment, the annular ring 18 includes a substantially consistent rectangular cross-sectional shape defined by the OD, the ID, and the distance T₁. For example, in the exemplary embodiment, as described above, the ID is preferably about 8½″. The OD is preferably about nine and one-half inches (9½″), thereby defining a generally square cross-sectional shape of the annular ring 18. As noted, other OD and ID distances are contemplated, and the distances defined herein are exemplary only.

In addition, in the illustrated embodiment, the rod 24 has a substantially consistent rectangular cross-sectional shape that is transverse to the longitudinal axis A. The cross-sectional shape is defined by the distance T₁ and a predefined width “T₂” (shown in FIG. 4). The distance T₂ is in a range between and including about one-quarter of an inch (¼″) and about one inch (1″). In the exemplary embodiment, the distance T₂ is preferably about three-eighths of an inch (⅜″).

It is noted that the annular ring 18 and the rod 24 may have any cross-sectional shape that enables the minnow bucket holder body 14 to function as described herein, including, for example, a changing cross-sectional shape, a curved profile, an arced profile, a square profile, and/or any combination thereof.

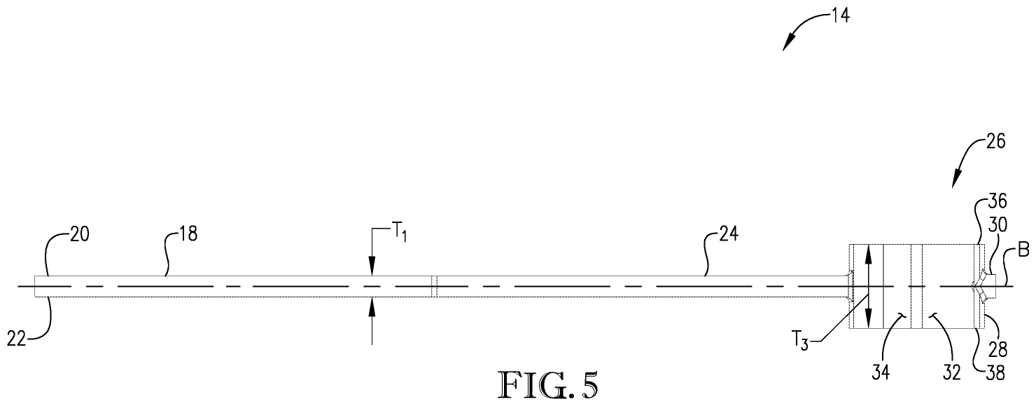

As shown in FIG. 5, the minnow bucket holder body 14 defines a central plane “B” that extends through the minnow bucket holder body 14. In the exemplary embodiment, the central plane B is located at a midpoint between the top surface 20 and the opposite bottom surface 22. In alternative embodiments, the central plane B may be positioned at any point between the top and bottom surfaces 20 and 22 that enables the minnow bucket holder body 14 to function as described herein.

The minnow bucket holder body 14 also includes a connecting clamp 26 coupled to an end of the rod 24 opposite the annular ring 18. The connecting clamp 26 is configured for attachment to a solid or hollow bar of circular or non-circular cross-section, such as the pedestal 11. As illustrated in FIGS. 4 and 5, the connecting clamp 26 includes a yoke 28 having a threaded boss 30 coupled thereto. The yoke 28 includes two substantially planar walls 32 and 34, oriented at a right angle to each other. The planar walls 32 and 34 extend substantially perpendicular to the central plane B, between a top surface 36 and a substantially parallel opposite bottom surface 38 spaced a predefined distance “T₃” from the top surface 36. In the exemplary embodiment, the distance T₃ is preferably about two inches (2″), although other distances are contemplated. In the exemplary embodiment, the top surface 36 and the bottom surface 38 are spaced from the central plane B substantially the same distance, although other spacing is contemplated.

A first end of the yoke 28 terminates in a first fixed jaw 40 oriented at a right angle to the planar wall 32, although other angles are contemplated. The first jaw 40 extends a predefined length “L₁” from the wall 32. In the exemplary embodiment, the length L₁ is preferably about nine-sixteenths of an inch ( 9/16″) long, although other distances are contemplated.

A second end of the yoke 28 terminates in a second fixed jaw 42 oriented at a right angle to the planar wall 34, although other angles are contemplated. The second jaw 42 extends a predefined length “L₂” from the wall 34. In the exemplary embodiment, the length L₂ is preferably about one and three-eighths of an inch (1⅜″) long, although other distances are contemplated. As such, the second jaw 42 is longer than the first jaw 40. In the example embodiment, the second jaw 42 and the planar wall 34 form the clamping surfaces configured to engage, for example, the pedestal 11. A gap “G₁” is defined between the ends of the first and second jaws 40 and 42 to facilitate receiving at least a portion of a solid or hollow bar of circular or non-circular cross-section therein, such as the pedestal 11. In the exemplary, the gap G₁ is about two and three-sixteenths of an inch (2 3/16″) across, although other distances are contemplated.

As illustrated in FIG. 4, the planar wall 34 is oriented at an oblique angle “A₁” with respect to the rod 24, and the corner connection between the planar wall 34 and the second jaw 42 is coupled to the rod 24 and positioned on the longitudinal axis A of the minnow bucket holder body 14. In the exemplary embodiment, the angle A₁ is about 135 degrees (135°), although other orientation angles are contemplated. Furthermore, in the exemplary embodiment, the planar walls 32 and 234 are substantially the same length, such that the connecting clamp 26 is generally square in shape, having only the gap G₁ cutout from the opposite sides. As illustrated in FIG. 4, one or more of the corners defined between adjacent walls and or walls and jaws are rounded to present a smooth, non-sharp corner.

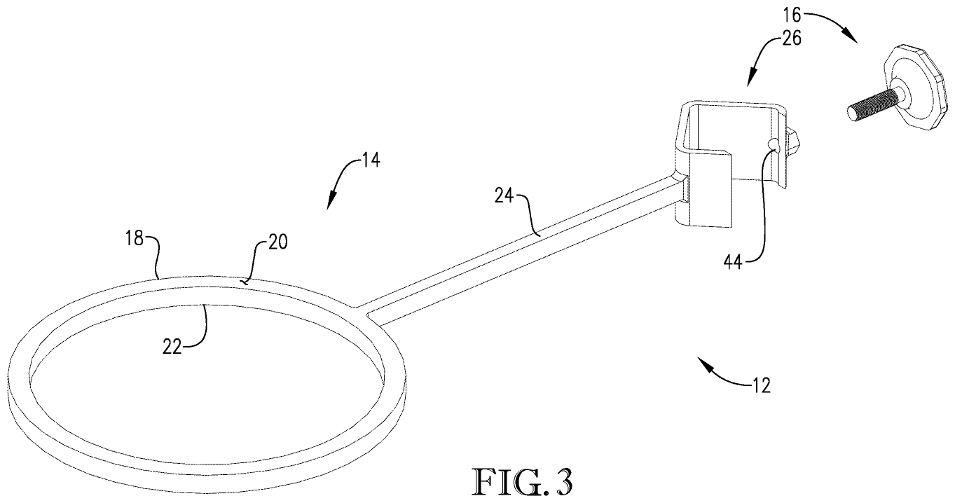

In the exemplary embodiment, the connecting clamp 26 includes an aperture 44 (best shown in FIG. 3) extending through at least a portion of the planar wall 32 and the first jaw 40 at their joining corner. The aperture 44 is substantially centered on the longitudinal axis A and the central plane B (i.e., diametrically opposed to the rod 24 relative to the connecting clamp 26) of the minnow bucket holder body 14, although other positioning is contemplated. The threaded boss 30 extends axially along the longitudinal axis A and is substantially concentric with the aperture 44 (i.e., diametrically opposed to the rod 24 relative to the connecting clamp 26). Internal threads 46 are formed through the threaded boss 30 for receiving the locking knob assembly 16. In the exemplary embodiment, the threaded boss 30 includes an internally threaded nut welded or otherwise suitably secured to the connecting clamp 26. Alternatively, the threaded boss 30 is formed as an integral component of the connecting clamp 26.

In the example embodiment, the minnow bucket holder body 14 (i.e., the annular ring 18, rod 24, and connecting clamp 26) is fabricated from a metal material, for example, without limitation, steel, stainless steel, iron, aluminum, brass, and the like. In one example embodiment, the annular ring 18, rod 24, and connecting clamp 26 may be separate elements welded together to form an integral minnow bucket holder body 14. Alternatively, the minnow bucket holder body 14 may be fabricated as an integrally formed solid structure, for example, using an additive manufacturing process, such as, direct metal laser melting, direct metal laser sintering, selective laser sintering, selective laser melting, electron beam melting, binder jet, and/or any other additive manufacturing process. In alternative embodiments, the minnow bucket holder body 14 may be fabricated from any number of materials, including a plastic or other rigid material. For example, without limitation, in one embodiment, the minnow bucket holder body 14 may be formed by an injection molding, forming, or extruding process used for fabricating parts from a thermoplastic or thermosetting plastic material and/or metal. Alternatively, the minnow bucket holder body 14 may be fabricated from a combination of materials, for example, buy attaching a non-metallic material to a metal or other rigid material. In some alternative embodiments, the minnow bucket holder body 14 is fabricated from any suitable material that enables the minnow bucket holder body 14 to function as described herein.

In operation, the connecting clamp 26 of the minnow bucket holder body 14 is slid onto the pedestal 11 such that the rod 24 extends generally horizontal (i.e., perpendicular to the pedestal 11) and away from the pedestal 11. More particularly, the pedestal 11 is slid through the gap G₁ to be received within the connecting clamp 26. The annular ring 18 is positioned by a user with respect to the pedestal seat 10 in any of a number of circumferential positions around the pedestal 11. The user the tightens the locking knob assembly 16 against the pedestal 11, thereby preventing undesired rotation of the minnow bucket holder body 14 about the pedestal 11. Specifically, the locking knob assembly 16 serves to force the planar wall 34 and the second jaw 42 against the pedestal 11, providing firm, frictional engagement therebetween. A minnow bucket or other bait container (not shown) may be placed into the annular ring 18 where the bait is accessible to the user while sitting in or standing near the pedestal seat 10. In instances where the pedestal 11 is a square or rectangular-shaped tube as is well known, the right-angled walls and jaws of the connecting clamp 26 provide additional anti-rotation functionality to facilitate preventing rotation of the minnow bucket holder body 14 when coupled to the pedestal seat 10.

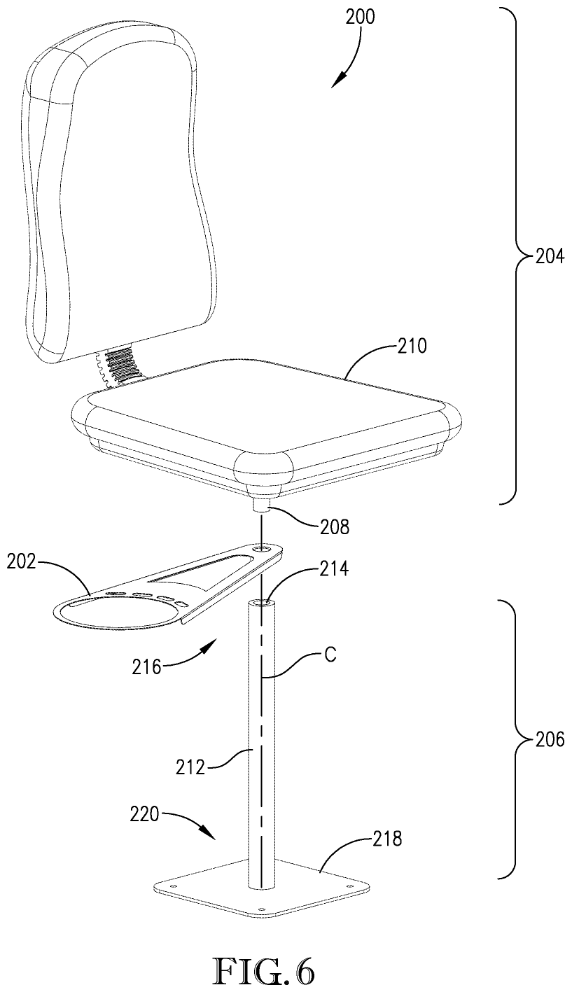

FIG. 6 is a perspective view of a pedestal seat assembly 200 having a pedestal-mountable minnow bucket holder 202 (broadly, a fishing bait container holding assembly), according to another embodiment of the disclosure. In the exemplary embodiment, the pedestal mountable minnow bucket holder assembly 202 is releasably securable to the pedestal seat assembly 200.

In the exemplary embodiment, the pedestal seat assembly 200 includes a seat assembly 204 and a pedestal assembly 206. The seat assembly 204 includes a seat post 208 coupled rigidly to an underside of a seat bottom 210. The pedestal assembly 206 includes a pedestal rod 212 having an aperture 214 formed in an upper end 216 concentric with a longitudinal axis “C” of the pedestal rod 212. The aperture 214 is configured with a diameter that is larger than a diameter of the seat post 208 to facilitate sliding the seat post 208 into the aperture 214. The pedestal assembly 206 also includes a mounting plate 218 coupled to a lower end 220 of the pedestal rod 212. The mounting plate 218 facilitates coupling the pedestal seat assembly 200 to a surface (not shown), such as the deck of a fishing boat.

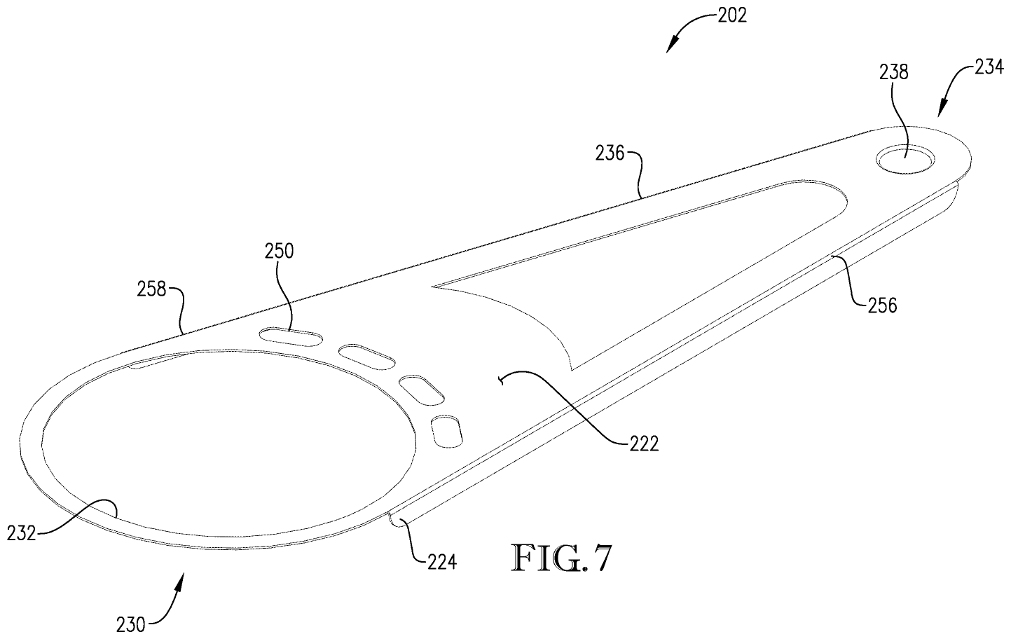

As illustrated in FIGS. 7-10, the minnow bucket holder 202 includes a plate-like body 222 having a generally thin planar body portion 236 defining a central longitudinal axis “D” and having a curved or semi-circular first end 230 defining a central opening 232, and a smaller curved or semi-circular second end 234. The curved second end 234 defines a central opening 238. The central longitudinal axis D passes through the center points of the central openings 232 and 238.

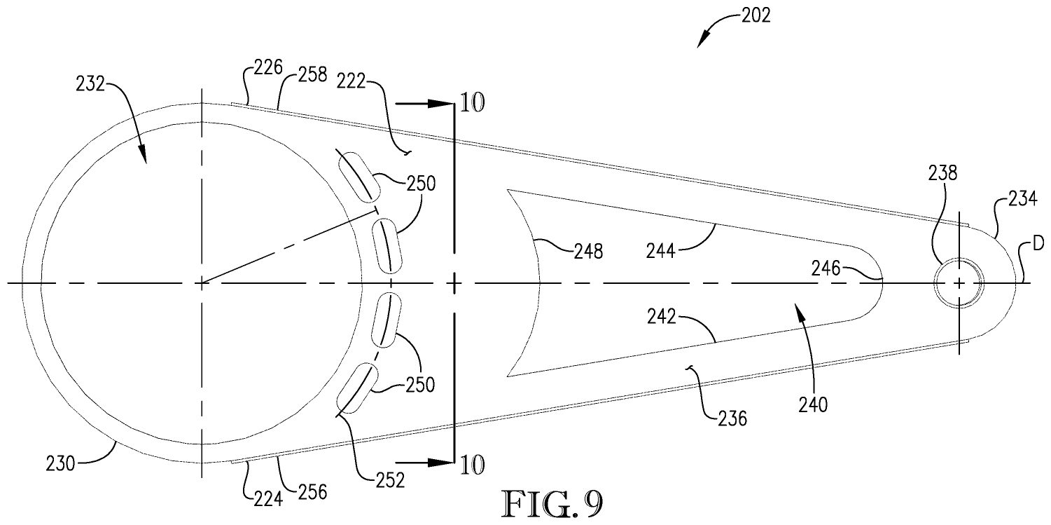

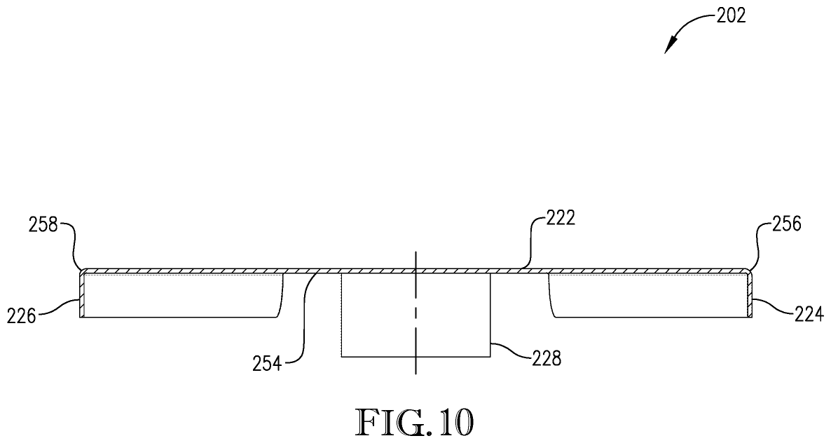

The plate-like body 222 includes a first flange 224 that extends longitudinally between the curved first end 230 and the curved second end 234 and is generally oriented tangent to each of the first and second curved ends 230 and 234. The first flange 224 projects generally perpendicular to the thin planar body portion 236. In addition, the center portion 236 includes an opposite second flange 226 (opposite with respect to the central longitudinal axis D, as shown in FIG. 9) that extends between the curved first end 230 and the curved second end 234 and is generally oriented tangent to each of the first and second curved ends 230 and 234. The second flange 226 projects generally perpendicular to the thin planar body portion 236 in the same directions as the first flange 224, as best illustrated in FIG. 10.

With reference to FIG. 9, the thin planar body portion 236 includes an elongate opening 240 defined therethrough. The elongate opening 240 is generally triangular in shape including a first edge 242, which is substantially parallel to the first flange 224, and a second edge 244, which is substantially parallel to the second flange 226. The first edge 242 and the second edge 244 are connected to each other near the second curved end 234 via a concave semi-circular edge 246. At the opposite end, the first edge 242 and the second edge 244 are connected to each other near the first curved end 230 via a convex semi-circular edge 248. The elongate opening 240 facilitates reducing the weight of the pedestal-mountable minnow bucket holder 202, while not reducing the structural integrity of the pedestal-mountable minnow bucket holder 202.

In the exemplary embodiment, the thin planar body portion 236 includes a plurality of substantially similar-shaped slots 250 defined therethrough for receiving, for example, and without limitation, a tool or tools such as the pliers, side cutters, and/or other fishing equipment or accessories. The slots 250 are generally racetrack-like shapes, having two generally parallel sides joined by semi-circular ends. In addition, the slots 250 are spaced equidistant along a semi-circular arc 252 that has a center point coincident with the center point of the central opening 232. While each slot 250 is illustrated as having a generally racetrack-like shape, it is contemplated that the slots may have any shape that enables the pedestal-mountable minnow bucket holder 202 to function as described herein (e.g., oval, arced, circular, etc.).

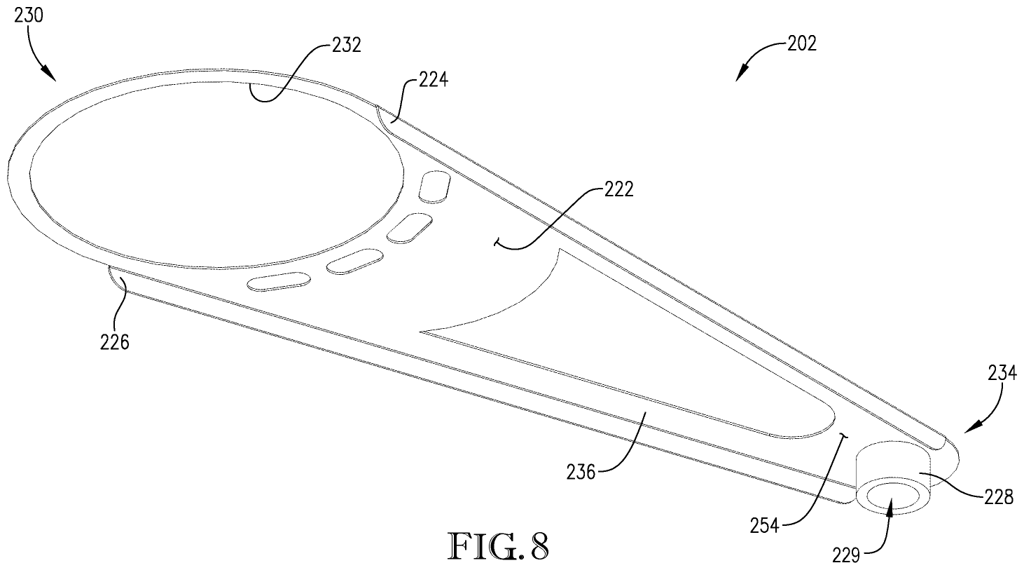

With reference to FIG. 8, the thin plate-like body 222 includes a mounting boss 228 coupled to and extending from a bottom surface 254 of the thin planar body portion 236. The mounting boss 228 is generally tubular-shaped defining a bore 229 therethrough, although other configurations are contemplated. The bore 229 is aligned with the central opening 238. In the exemplary embodiment, the mounting boss 228 may be coupled to the thin planar body portion 236, for example, via a welding process. Alternatively, the mounting boss may be formed integrally with the thin planar body portion 236 and/or coupled thereto in any manner that enables the pedestal-mountable minnow bucket holder 202 to function as described herein.

FIG. 10 is a cross-sectional view of the pedestal-mountable minnow bucket holder 202, taken about line 10-10 shown in FIG. 9. In the exemplary embodiment, the thin plate-like body 222 may be fabricated, in part, from a single sheet component (e.g., a single sheet of material), such as steel sheet having a predetermined thickness (not shown). With continued reference to FIGS. 7, 9, and 10, a first bend radius 256 (or radius of curvature) is defined longitudinally in the thin plate-like body 222 defining the joining edge of the first flange 224 and the thin planar body portion 236. The thin plate-like body 222 includes a second bend radius 258 defined longitudinally therein and defining the joining edge of the second flange 226 and the thin planar body portion 236.

In operation, the seat post 208 is placed through the central opening 238 and bore 229 adjacent the second end 234 of the thin plate-like body 222 and then placed into the aperture 214 of the pedestal rod 212 to assemble the seat assembly 204 to the pedestal assembly 206. This facilitates supporting the pedestal-mountable minnow bucket holder 202 at a height with respect to the seat bottom 210 such that the pedestal-mountable minnow bucket holder 202 is accessible to a user while sitting in or standing near the pedestal seat assembly 200. The pedestal-mountable minnow bucket holder 202 and the seat assembly 204 can swivel about the longitudinal axis C defined by the centerline of the pedestal rod 212, the aperture 214, and the seat post 208. As such, the pedestal-mountable minnow bucket holder 202 can be positioned within reach of the user and swiveled out of the way when not in use.

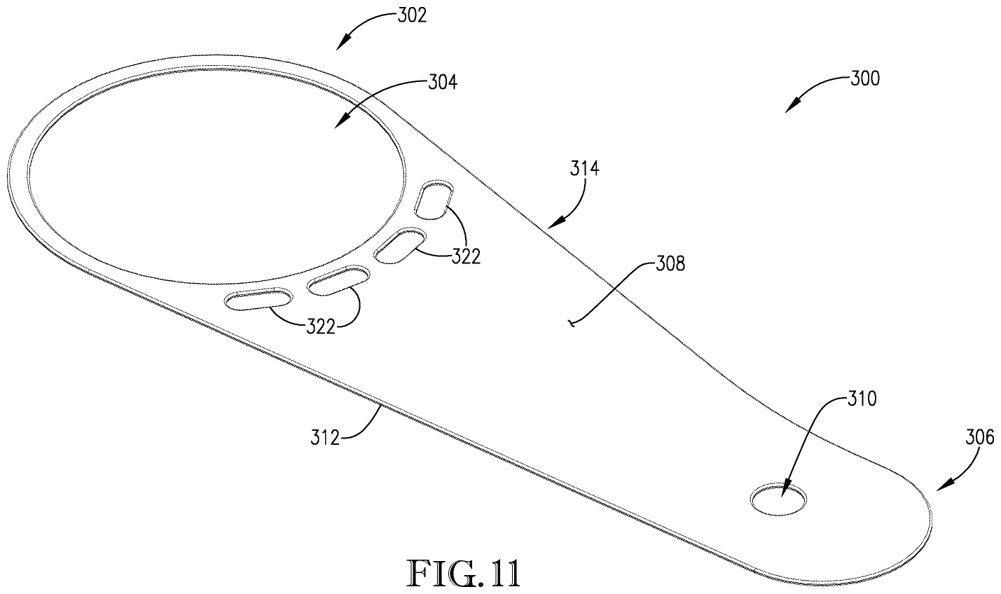

FIG. 11 is a perspective view of an alternative pedestal-mountable minnow bucket holder 300 (broadly, a fishing bait container holding assembly) that may be used with the pedestal seat assembly 200 (shown in FIG. 6). In the exemplary embodiment, the pedestal mountable minnow bucket holder assembly 300 is releasably securable to the pedestal seat assembly 200.

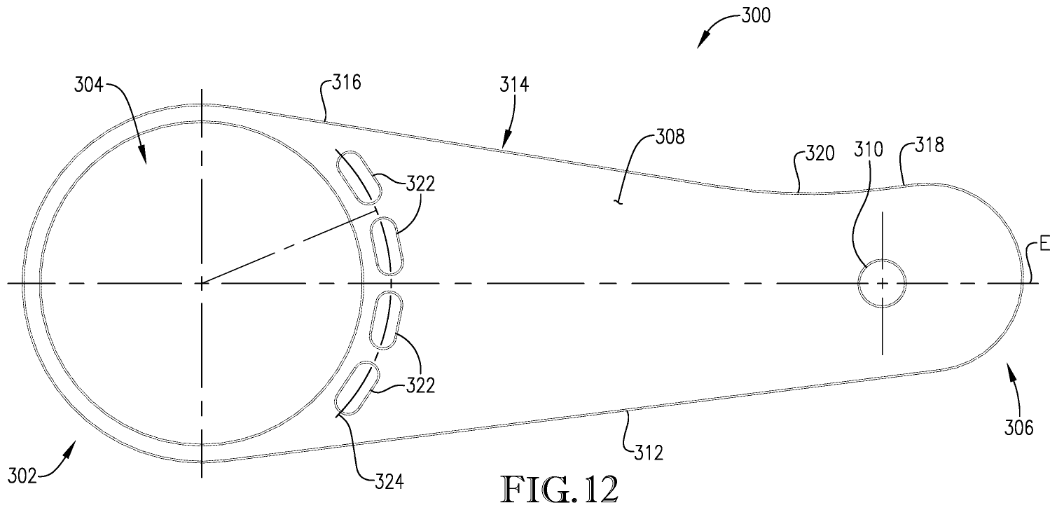

As illustrated in FIGS. 11 and 12, the pedestal-mountable minnow bucket holder 300 is a generally thin plate-like body that may be fabricated, for example, from a single sheet component (e.g., a single sheet of material), such as a rigid plastic or metal sheet having a predetermined thickness (not shown). The pedestal-mountable minnow bucket holder 300 defines a central longitudinal axis “E” and includes a curved or semi-circular first end 302 defining a central opening 304. A smaller curved or semi-circular second end 306 is joined to the curved first end 302 via a center portion 308. The curved second end 306 includes an opening 310 configured to receiving the seat post 208 (shown in FIG. 6). The central longitudinal axis E passes through the center points of the central opening 304 and the opening 310.

The center portion 308 includes a first edge 312 that extends longitudinally between the curved first end 302 and the curved second end 306 and is generally oriented tangent to each of the first and second curved ends 302 and 306. In addition, the center portion 308 includes an opposite second edge 314 (opposite with respect to the central longitudinal axis E, as shown in FIG. 12) that extends between the curved first end 302 and the curved second end 306. The second edge 314 includes a first portion 316 that extends a predefined distance from the first end 302. The first portion 316 is generally oriented tangent to the first curved end 302 and joins to a second portion 318 proximate the second end 306. The second portion 318 is generally oriented tangent to the second curved end 306 and extends substantially parallel to the first edge 312 a predefined distance. A radius 320 is defined at the joint between the first portion 316 and the second portion 318. While the second edge 314 is illustrated as a bent or otherwise non-straight edge, it is contemplated that the second edge 314 can be a single straight edge extending between the first and second curved ends 302 and 306, substantially similar to the first edge 312.

In the exemplary embodiment, the pedestal-mountable minnow bucket holder 300 includes a plurality of substantially similar-shaped slots 322 defined therethrough. The slots 322 are generally rectangular in shape, having semi-circular ends. In addition, the slots 322 are spaced equidistant along a semi-circular arc 324 that has a center point coincident with the center point of the central opening 304. While each slot 322 is illustrated as having a generally rectangular shape, it is contemplated that the slots may have any shape that enables the pedestal-mountable minnow bucket holder 300 to function as described herein (e.g., oval, arced, circular, etc.).

In operation, the seat post 208 is placed through the opening 310 adjacent the second end 306 of the pedestal-mountable minnow bucket holder 300 and then placed into the aperture 214 (shown in FIG. 6) of the pedestal rod 212 (shown in FIG. 6) to assemble the seat assembly 204 (shown in FIG. 6) to the pedestal assembly 206 (shown in FIG. 6). This facilitates supporting the pedestal-mountable minnow bucket holder 300 at a height with respect to the seat bottom 210 (shown in FIG. 6) such that the pedestal-mountable minnow bucket holder 300 is accessible to a user while sitting in or standing near the pedestal seat assembly 200. The pedestal-mountable minnow bucket holder 300 and the seat assembly 204 can swivel about the longitudinal axis C defined by the centerline of the pedestal rod 212, the aperture 214, and the seat post 208. As such, the pedestal-mountable minnow bucket holder 300 can be positioned within reach of the user and swiveled out of the way when not in use.

With respect to the above description, it is noted that the optimal dimensional relationships for the components of the embodiments, to include variations in size, materials, shape, form, function, and manner of operation, assembly, and use, are deemed readily apparent to one skilled in the art, and all equivalent relationships to those illustrated in the drawings and described in the specification are intended to be encompassed by an embodiment of the disclosure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pedestal-mountable minnow bucket holder comprising:
an annular ring having a top surface and an opposite bottom surface, said annular ring defining a central plane between said top and bottom surfaces;
a rod coupled to said annular ring, said rod extending radially outward from said annular ring substantially parallel to the central plane; and
a connecting clamp coupled to said rod opposite said annular ring, said connecting clamp comprising a yoke defining a gap for at least partially receiving a pedestal extending through said connecting clamp, said yoke comprising a first planar wall and a second planar wall oriented at a right angle to said first planar wall and to define a first corner of said yoke.

2. The pedestal-mountable minnow bucket holder in accordance with claim 1,
said yoke comprising a first fixed jaw coupled to said first planar wall opposite said second planar wall, said first fixed jaw oriented at a right angle to said first planar wall to define a second corner of said yoke, said first fixed jaw defining a first edge of the gap.

3. The pedestal-mountable minnow bucket holder in accordance with claim 2,
said connecting clamp comprising an aperture defined through at least a portion of said first planar wall and said first jaw at said second corner.

4. The pedestal-mountable minnow bucket holder in accordance with claim 3,
said connecting clamp comprising a threaded boss positioned substantially concentric with said aperture, said threaded boss comprising internal threads extending therethrough; and
a locking knob assembly threadedly received in said threaded boss.

5. The pedestal-mountable minnow bucket holder in accordance with claim 2,
said yoke comprising a second fixed jaw coupled to said second planar wall opposite said first planar wall, said second fixed jaw oriented at a right angle to said second planar wall to define a third corner of said yoke, said second fixed jaw defining a second edge of the gap.

6. The pedestal-mountable minnow bucket holder in accordance with claim 5,
said first fixed jaw extending a first predefined length; and
said second fixed jaw extending a second predefined length,
wherein said second predefined length is greater than said first predefined length, and
wherein said second fixed jaw and said second planar wall are configured to engage the pedestal.

7. The pedestal-mountable minnow bucket holder in accordance with claim 5,
said rod being linear in shape,
said third corner of said yoke coupled to said rod.

8. The pedestal-mountable minnow bucket holder in accordance with claim 1,
said rod being linear in shape,
said first planar wall oriented at an oblique angle with respect to said rod.

9. The pedestal-mountable minnow bucket holder in accordance with claim 1,
said first planar wall and a second planar wall having a substantially similar length such that said yoke is generally square in shape.

10. The pedestal-mountable minnow bucket holder in accordance with claim 1,
said annular ring comprising an outside diameter and a concentric inside diameter defining an opening sized and configured to receive a minnow bucket, said annular ring having a substantially consistent rectangular cross-sectional shape.

11. The pedestal-mountable minnow bucket holder in accordance with claim 1,
said rod being linear in shape,
said rod comprising a substantially consistent rectangular cross-sectional shape.

12. The pedestal-mountable minnow bucket holder in accordance with claim 1, further comprising a locking knob assembly threadedly coupled to said connecting clamp.

13. The pedestal-mountable minnow bucket holder in accordance with claim 1,
said pedestal-mountable minnow bucket holder comprising an integrally formed solid structure.

14. The pedestal-mountable minnow bucket holder in accordance with claim 1,
said first planar wall and said second planar wall extending perpendicular to the central plane.

15. A pedestal-mountable minnow bucket holder comprising:
a plate-like body including—
a semi-circular first end presenting a first radius, said first end defining a first opening sized and configured to receive a minnow bucket,
a semi-circular second end presenting a second radius smaller than the first radius, said second end defining a second opening sized and configured to receive at least a portion of a pedestal therethrough, and
a tapered center portion extending between said first end and said second end, said tapered center section comprising at least one straight edge oriented tangent to said first end and said second end.

16. The pedestal-mountable minnow bucket holder in accordance with claim 15,
said first opening formed concentric with said first end.

17. The pedestal-mountable minnow bucket holder in accordance with claim 15,
said tapered center portion comprising a first flange and an opposite second flange, said first and second flanges extending longitudinally between said first end and said second end and oriented tangent to said first and second ends.

18. The pedestal-mountable minnow bucket holder in accordance with claim 15,
said plate-like body further comprising a tubular mounting boss extending from said second end, said mounting boss being concentric with said second opening.

19. The pedestal-mountable minnow bucket holder in accordance with claim 15,
said plate-like body further comprising a plurality of apertures formed therethrough, said plurality of apertures spaced equidistant along a semi-circular arc that has a center point coincident with a center point of said first opening.

20. The pedestal-mountable minnow bucket holder in accordance with claim 19,
said apertures being substantially similar in shape and size.
